(19) United States
(12) Patent Application Publication
(10) Pub. No.: US 2009/0268999 A1
(43) Pub. Date: Oct. 29, 2009

(54) LOW LOSS OPTICAL POLYMER AND DEVICES MADE THEREFROM

(75) Inventor: Diyun Huang, Watertown, MA (US)

Correspondence Address: GRAYBEAL JACKSON LLP, 155 - 108TH AVENUE NE, SUITE 350, BELLEVUE, WA, 98004-5973, US

(73) Assignee: GIGOPTIX, INC., Bothell, WA (US)

(21) Appl. No.: 12/432,662

(22) Filed: Apr. 29, 2009

Related U.S. Application Data
(63) Continuation-in-part of application No. 11/383,695, filed on May 16, 2006, now abandoned.

(51) Int. Cl. G02F 1/035; G02F 1/00; G02B 6/00

(52) U.S. Cl. 385/2; 252/583; 385/122

(57) ABSTRACT

A electro-optic composite comprising a polymer having the structure

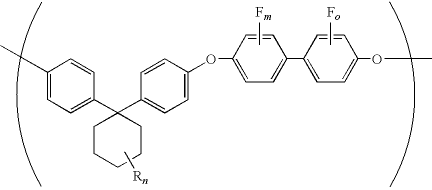

and a nonlinear optical chromophore having the structure D-π-A, wherein:
R is an alkyl, aryl, heteroalkyl, or heteroaryl, group;
D is a donor;
π is a π bridge;
A is an acceptor;
n=0-4;
m=1-4; and
o=1-4.

### CROSS-REFERENCE TO RELATED APPLICATIONS

The present application is a Continuation-in-Part of copending U.S. patent application Ser. No. 11/383,695, filed May 16, 2006; entitled “LOW LOSS ELECTRO-OPTIC POLYMERS COMPOSITES”, invented by Diyun Huang, which application is incorporated herein by reference in its entirety.

### BACKGROUND

Polymer optical devices may include passive and active devices including a core and a cladding. A refractive index contrast between core and cladding, wherein the cladding has a refractive index lower than the refractive index of the core, may guide light along the core. At least a portion of the light power may be present as an evanescent wave in the cladding material.

Electro-optic polymers are advantageous materials for optical device design because they have higher electro-optic activity than inorganic materials such as lithium niobate (LiNbO₃). Many electro-optic polymers have been developed, and many are “guest-host” systems where a nonlinear optical chromophore guest is present as a host in a polymer matrix (i.e., the chromophore is not covalently attached to the polymer matrix). However, many guest-host composites show relatively high optical loss, which depends on both the structure of the chromophore and the polymer. Poly[bisphenol A carbonate-co-4,4′-(3,3,5-trimethylcyclohexylidene)diphenol carbonate], which is also referred to as “amorphous polycarbonate” or “APC,” has been used previously with certain chromophores to give high electro-optic activity composites with relatively low optical loss (<1.5 dB/cm). However, many chromophores do not give low optical loss composites with APC due to chromophore/polymer phase separation and resulting light scattering. Fluorinating the polymer is a method to reduce optical loss due to absorption in the polymer matrix itself, but this often leads to high optical loss in composite materials due to increased phase separation between the chromophore and the matrix. Consequently, there is still a need for a polymer matrix of an electro-optic polymer composite that is fluorinated to reduce absorptive optical loss, but does not show increased optical loss due to phase separation.

### SUMMARY

According to an embodiment, an optical polymer material includes a polymer having the structure:

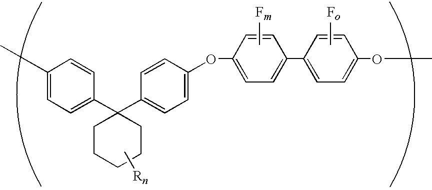

According to an embodiment, an electro-optic composite includes a polymer (i.e., matrix) having the structure

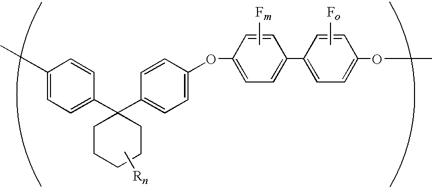

and a nonlinear optical chromophore having the structure D-π-A, wherein: R is an alkyl, aryl, heteroalkyl, or heteroaryl, group; D is a donor; π is a π bridge; A is an acceptor; n=0-4; m=1-4; ando=1-4.

The polymers and electro-optic composites show a relatively low optical loss (<1.5 dB/cm) compared to composites with APC polymer matrices and similar chromophores (>2.3 dB/cm). The low optical loss may be unusual given that matrix is fluorinated and that the fluorinated monomer is rigid. Both fluorination and rigidity in the polymer matrix normally tends to increase phase separation and increase optical loss.

### BRIEF DESCRIPTION OF THE DRAWINGS

FIG. 1 illustrates donors according to some embodiments.

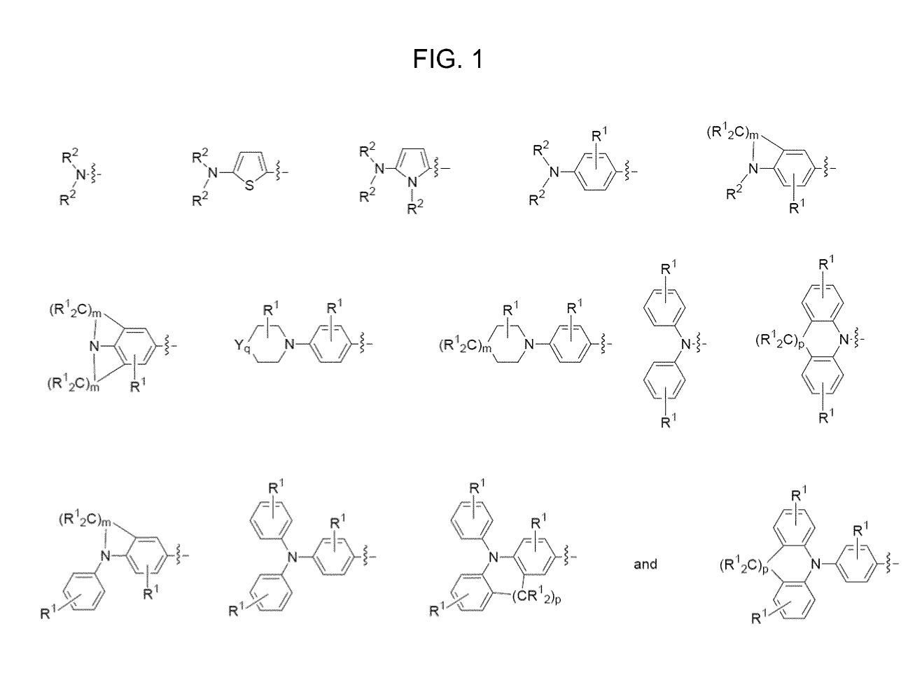

FIG. 2 illustrates acceptors according to some embodiments.

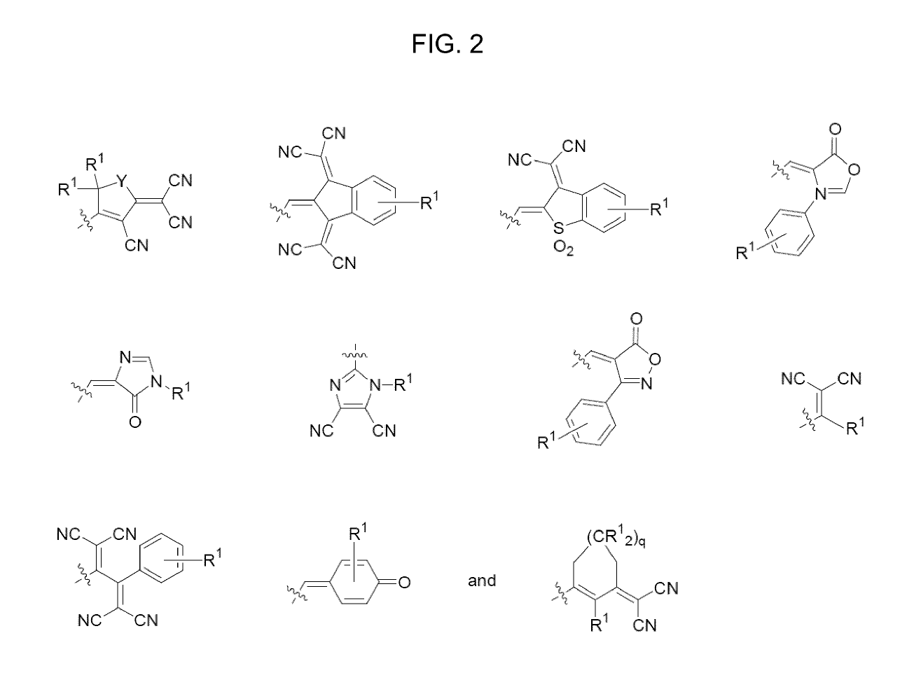

FIG. 3 illustrates synthesis of a chromophore used in combination with a fluorinated polymer, according to some embodiments.

FIG. 4 illustrates synthesis of a polymer according to an embodiment.

FIG. 5 illustrates a chromophore used in some embodiments.

FIG. 6 is a cross-section of an active region of an electro-optic device, according to an embodiment.

FIG. 7 is a cross-section of a passive structure of an optical device, according to an embodiment.

### DETAILED DESCRIPTION

In the following detailed description, reference is made to the accompanying drawings, which form a part hereof. In the drawings, similar symbols typically identify similar components, unless context dictates otherwise. Other embodiments may be used and/or and other changes may be made without departing from the spirit or scope of the disclosure.

According to an embodiment, an optical polymer material includes a polymer having the structure:

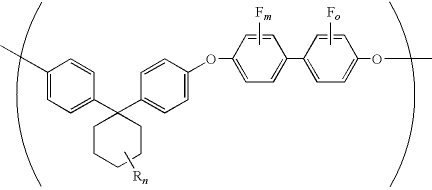

According to an embodiment, an electro-optic composite includes a polymer having the structure

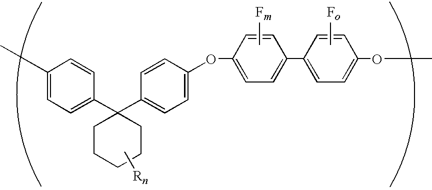

and a second order nonlinear optical chromophore having the structure D-π-A, wherein: R is an alkyl, aryl, heteroalkyl, or heteroaryl, group; D is a donor; π is a π bridge; A is an acceptor; n=0-4; m=1-4; and o=1-4. In some embodiments, m=4 and n=4. In some embodiments where m=4 and n=4, R=—CH₃ (i.e., a methyl group) and n=3. In other embodiments, the π bridge includes a thiophene ring having oxygen atoms bonded directly to the 3 and 4 positions of the thiophene ring. In some of those embodiments, the oxygen atoms are independently substituted with an alkyl, heteroalkyl, aryl, or heteroaryl group. Examples of chromophores where the oxygen atoms bonded directly to the 3 and 4 positions of the thiophene are independently substituted with an alkyl, heteroalkyl, aryl, or heteroaryl group comprise the structures

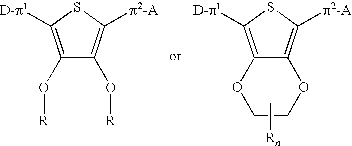

wherein: D is a donor; π¹ is a π bridge; π² is a π bridge; A is an acceptor; and n=0-4.

In certain embodiments, the donor (D) of the chromophore is selected from the group consisting of:

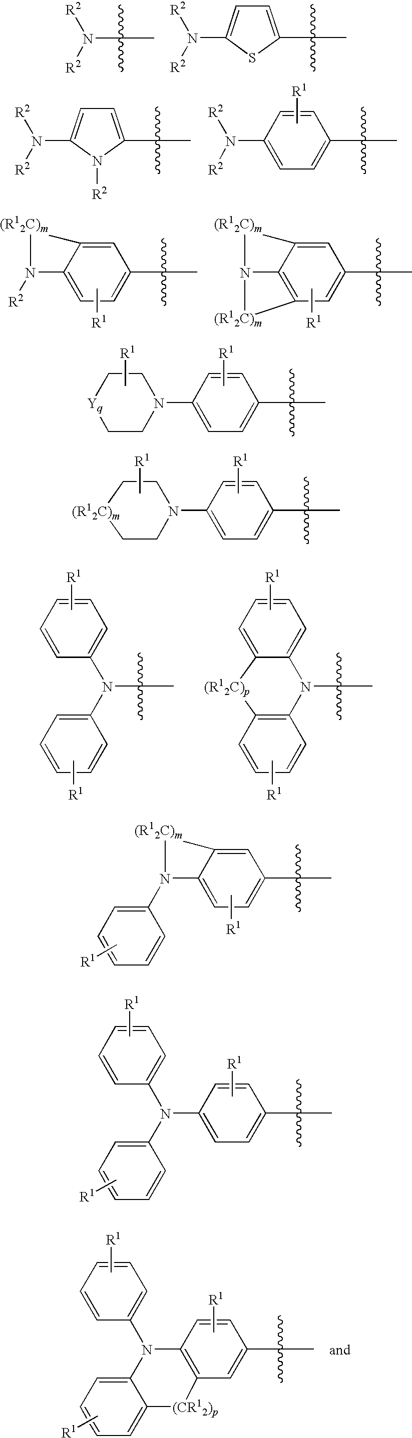

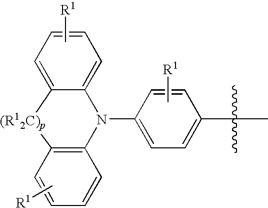

and the acceptor (A) is selected from the group consisting of

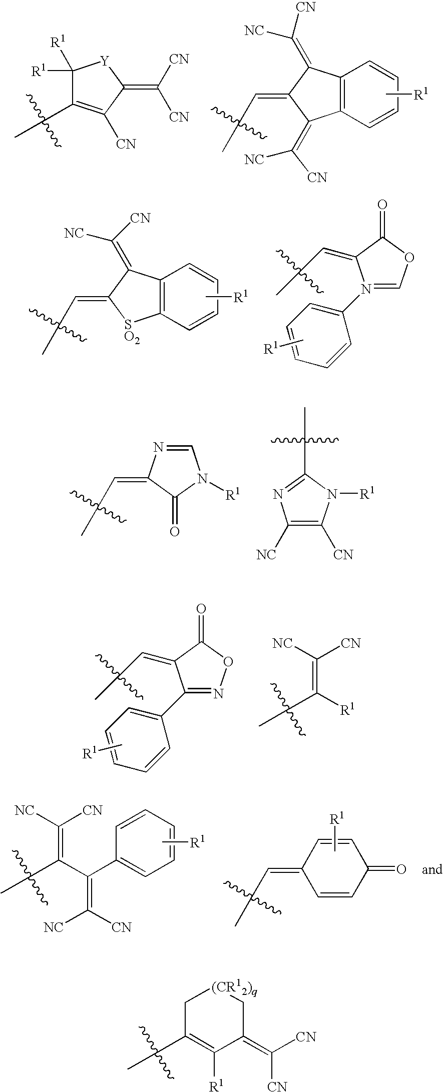

wherein independently at each occurrence: R¹ is hydrogen, a halogen, an alkyl, aryl, heteroalkyl, or heteroaryl group; R² is hydrogen, an alkyl, aryl, heteroalkyl, or heteroaryl group; Y is O, S or Se; m is 2, 3 or 4; p is 0, 1 or 2; and q is 0 or 1.

According to an embodiment, the donor is selected from the group consisting of

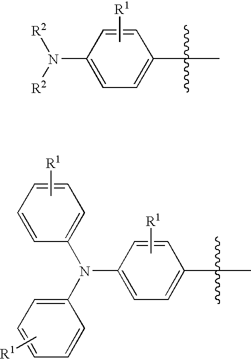

wherein, independently at each occurrence: R¹ is hydrogen, a halogen except when bonded to a carbon alpha to or directly to a nitrogen, oxygen, or sulfur atom, or an alkyl, aryl, heteroalkyl, or heteroaryl group; and R² is hydrogen or an alkyl, aryl, heteroalkyl, or heteroaryl group. In some embodiments, π¹ and π² are both

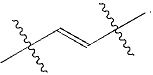

In other embodiments, A is

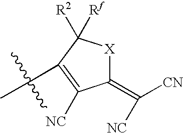

wherein R^{f} is selected from the group consisting of

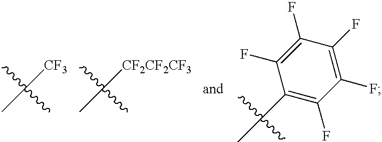

R² is an alkyl group; and X is O or S.

A further embodiment is an electro-optic device comprising the electro-optic composite described above. The electro-optic device may comprise a Mach-Zehnder interferometer, a directional coupler, or a microring resonator.

### EXAMPLES

The following example(s) is illustrative and does not limit the Claims.

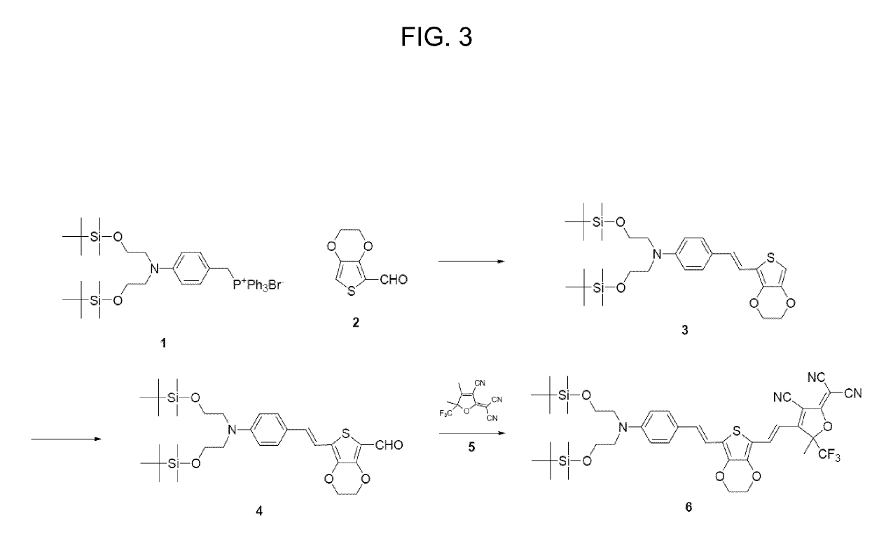

The following steps are illustrated in FIG. 3.

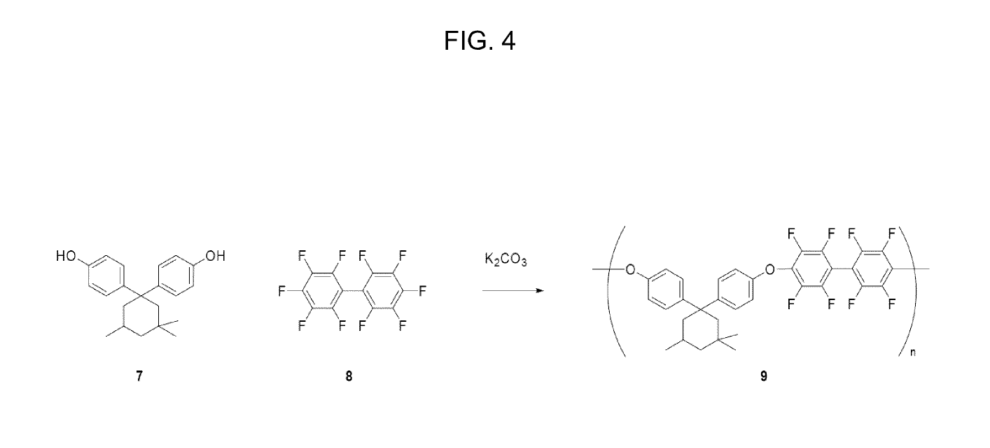

Compound 3: Referring to FIG. 3, compound 1 (50 g, 0.065 mol) was dissolved in 700 mL THF. At −40° C., BuLi (2.5 M, 29 mL, 0.072 mol) was added dropwise. After addition, it was warmed to rt for 30 min. Compound 2 (11.1 g, 0.065 mol) was dissolved in 300 mL THF and added to the above solution. It was stirred at rt overnight. After removing the solvent, the reaction mixture was purified by column chromatography with CH₂Cl₂. The product, 30.6 g, was obtained in 81% yield.
Compound 4: Compound 3 (30.5 g, 0.053 mol) was dissolved in 200 mL THF. At −78° C., BuLi (2.5 M, 42 mL, 0.106 mol) was added dropwise. It was warmed to −20° C. and then cooled down again. At −78° C., DMF (16.4 mL, 0.212 mol) was added. It was stirred overnight. The reaction mixture was extracted with CH₂Cl₂, washed with water, and dried over MgSO₄. After removal of the solvent, it was purified by column chromatography with CH₂Cl₂. The product, 22.93 g, was obtained in 72% yield.
Chromophore 6: Compound 4 (4.06 g, 6.7 mmol) and compound 5 (1.7 g, 6.7 mmol) were dissolved in 80 mL of EtOH. It was heated at 50° C. for 1 hour. After cooling to rt, the solid was collected by filtration, and further purified by column chromatography with CH₂Cl₂/ethyl acetate (8:0.2). The product, 3.95 g, was obtained in 70% yield.
Polymer 9: Referring to FIG. 4, compound 7 (10 g, 0.0322 mol) and compound 8 (10.76 g, 0.0322 mol) were dissolved in 100 mL DMAc and K₂CO₃ (6.68 g, 0.048 mol) was then added. It was heated at 120° C. for 3 hours with Dean-Stark equipment charged with 30 mL benzene. The reaction mixture was first precipitated into MeOH/water and then further purified by dissolving in THF and precipitating with MeOH three times. The product, 17.1 g, was obtained in 88% yield.

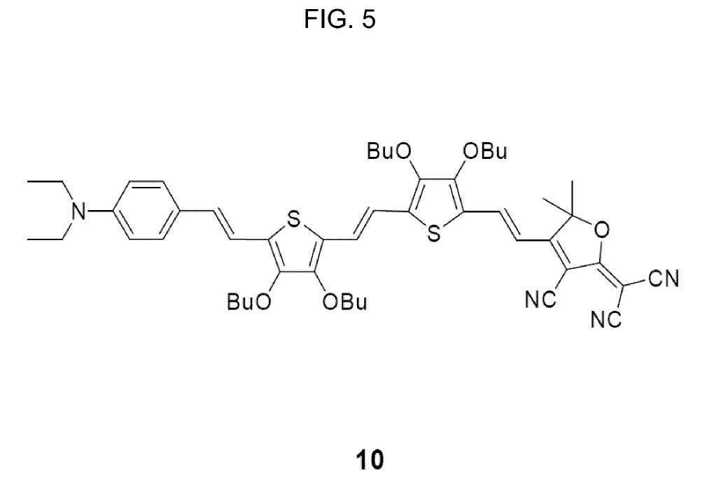

Electro-optic composites were prepared by spin coating a solution of approximately 25% by weight of chromophore 6 or chromophore 10 (FIG. 5), which is described in U.S. Pat. No. 6,750,603, in polymer 3, FIG. 26 on 2 inch indium tin oxide (ITO) coated glass wafers, incorporated by reference herein. The solvent for the chromophore/polymer solution was either cyclopentanone or dibromomethane. The optical loss of the composites of polymer 9 measured at 1550 nm were remarkably low (<1.5 dB/cm) compared to the same chromophores in commercial amorphous polycarbonate, “APC” (>2.3 dB/cm). The composites were electrode poled to induce electro-optic activity.

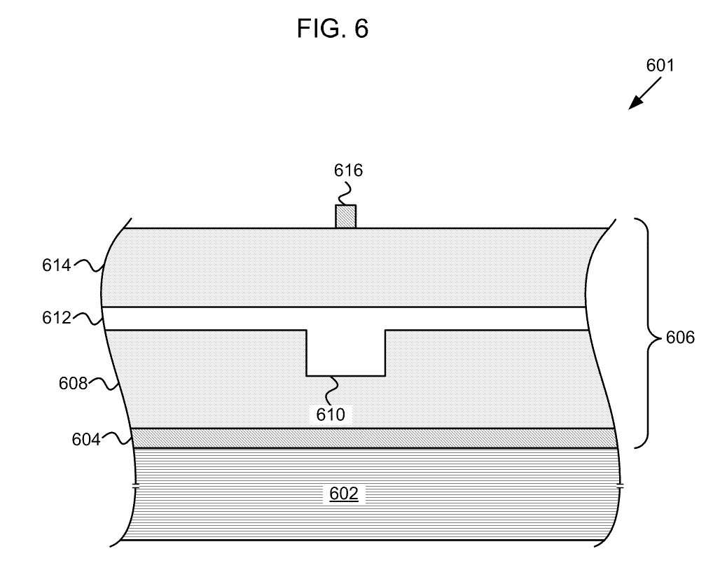

FIG. 6 is a cross-section of an active region 601 of an electro-optic device, according to an embodiment. A substrate 602, such as silicon, silicon-on-insulator, glass, or polymer supports a bottom electrode 604 and a polymer optical stack 606. The polymer optical stack 606 includes a bottom cladding 608 having a trench waveguide 610 formed therein. A polymer composite layer 612 fills the trench waveguide 610 and overlies at least a portion of the bottom clad 608. The polymer composite layer 612 may include a polymer having the structure

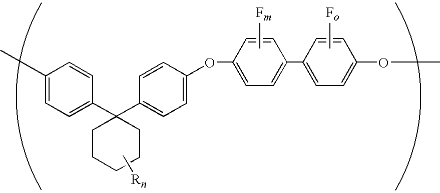

and a nonlinear optical chromophore having the structure D-π-A, wherein: R is an alkyl, aryl, heteroalkyl, or heteroaryl, group; D is a donor; π is a π bridge; and A is an acceptor, as described above.

A top cladding 614 overlies the polymer composite 612. A modulation electrode 616 lies on the top cladding 614, aligned with the waveguide 610.

According to alternative embodiments, other waveguide structures 610 may be used in place of or in addition to the trench waveguide 610 illustrated. For example, the active region 601 and/or other portions of the device may include a rib waveguide, a side clad waveguide, a semi-rib waveguide, a semi-trench waveguide, or other structures configured to guide light.

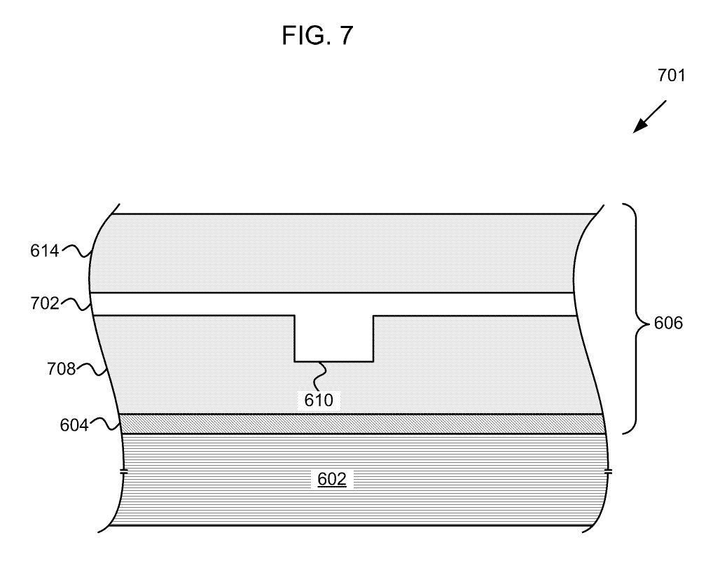

FIG. 7 is a cross-section of a passive structure 701 of an optical device, according to an embodiment. A substrate, such as silicon, silicon-on-insulator, glass, or polymer may support an optional bottom electrode 604 and a polymer optical stack 606. The polymer optical stack 606 includes a bottom cladding 608 having a trench waveguide 610 formed therein. A polymer layer 702 fills the trench waveguide 610 and overlies at least a portion of the bottom clad 608. The polymer layer 702 may include a polymer having the structure

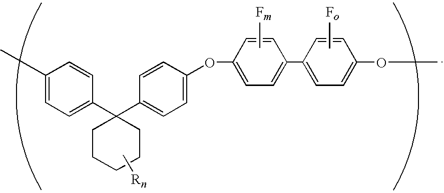

A top cladding 614 overlies the polymer layer 702. The passive structure 701 may be used, for example, to guide light to and from the active structure 601 of FIG. 6. The layer 702 of the passive structure 701 may taper to or abut the layer 612 of the active structure 601.

According to an embodiment, a polymer composite may include a first order non-linear optical chromophore or a third order non-linear optical chromophore. According to an embodiment, an optical device may include a composite of a polymer having the structure

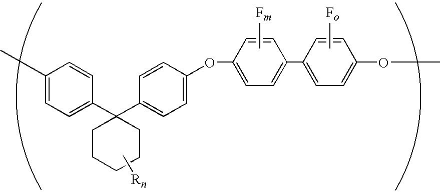

and a first order or third order nonlinear optical chromophore.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

1. A electro-optic composite comprising a polymer having the structure 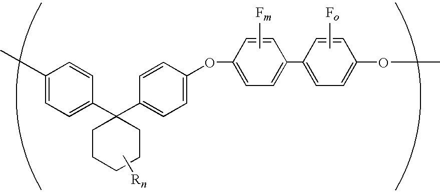
and a nonlinear optical chromophore having the structure D-π-A, wherein:
R is an alkyl, aryl, heteroalkyl, or heteroaryl, group;
D is a donor;
π is a π bridge;
A is an acceptor;
n=0-4;
m=1-4; and
o=1-4.

2. The electro-optic composite of claim 1, wherein m=4 and n=4.

3. The electro-optic composite of claim 2, wherein R=—CH₃ and n=3.

4. The electro-optic composite of claim 1, wherein the π bridge includes a thiophene ring having oxygen atoms bonded directly to the 3 and 4 positions of the thiophene ring.

5. The electro-optic composite of claim 4, wherein the oxygen atoms are independently substituted with an alkyl, heteroalkyl, aryl, or heteroaryl group.

6. The electro-optic composite of claim 5, wherein the nonlinear optical chromophore comprises 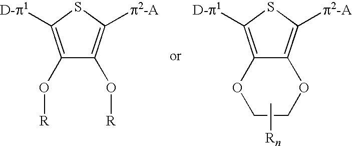
wherein: D is a donor; π¹ is a π bridge; π² is a π bridge; A is an acceptor, and n=0-4.

7. The electro-optic composite of claim 6 wherein the donor is selected from the group consisting of: 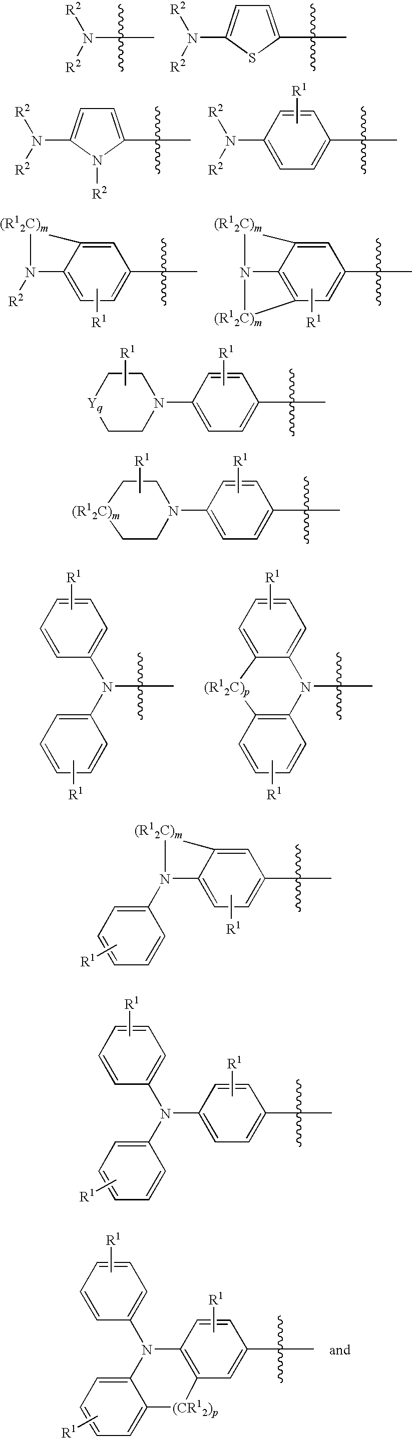 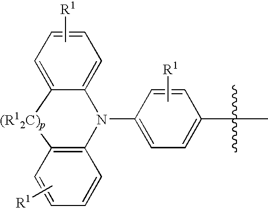
and the acceptor is selected from the group consisting of 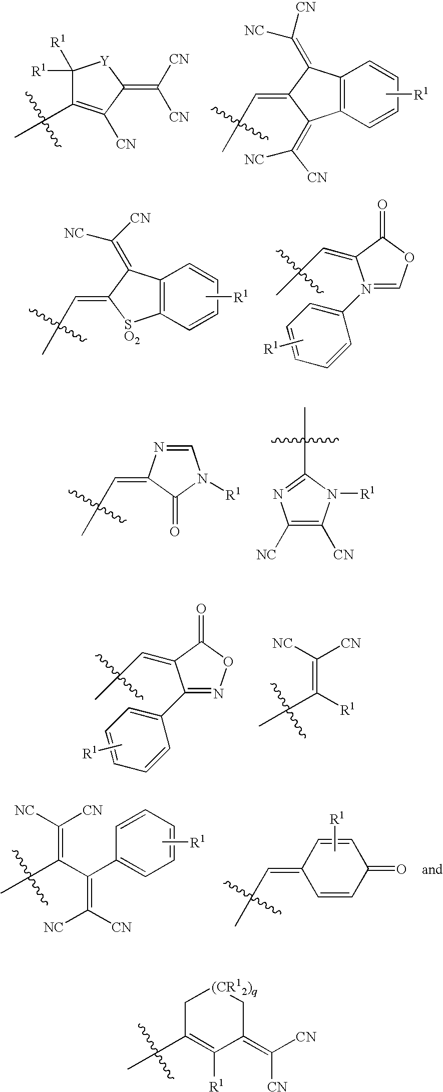
wherein independently at each occurrence: R¹ is hydrogen, a halogen, an alkyl, aryl, heteroalkyl, or heteroaryl group; R² is hydrogen, an alkyl, aryl, heteroalkyl, or heteroaryl group; Y is O, S or Se; m is 2, 3 or 4; p is 0, 1 or 2; and q is 0 or 1.

8. The electro-optic composite of claim 7, wherein the donor is selected from the group consisting of 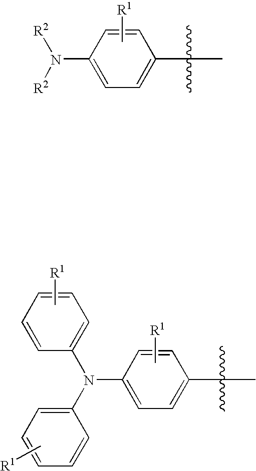
wherein, independently at each occurrence: R¹ is hydrogen, a halogen except when bonded to a carbon alpha to or directly to a nitrogen, oxygen, or sulfur atom, or an alkyl, aryl, heteroalkyl, or heteroaryl group; and R² is hydrogen or an alkyl, aryl, heteroalkyl, or heteroaryl group.

9. The electro-optic composite of claim 8, wherein π¹ and π² are both

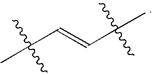

10. The electro-optic composite of claim 1, wherein A is 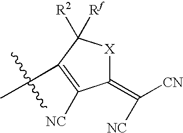
R^{f} is selected from the group consisting of 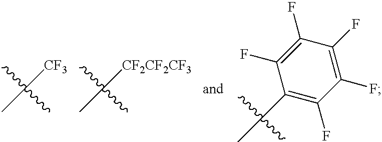
R² is an alkyl group; and X is O or S.

11. An electro-optic device comprising the electro-optic composite of claim 1.

12. The electro-optic device of claim 11, wherein the electro-optic device comprises a Mach-Zehnder interferometer, a directional coupler, or a microring resonator.

13. An optical device, comprising:
a waveguide core including a polymer having the structure 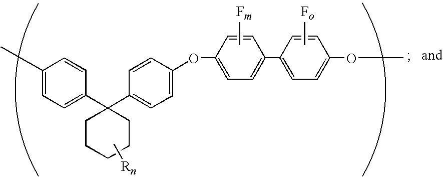
a polymer cladding having a refractive index lower than the refractive index of the waveguide core.

14. The optical device of claim 13, wherein the waveguide core includes a passive device.

15. The optical device of claim 13, wherein the waveguide core includes a nonlinear optical chromophore.

16. The optical device of claim 15, wherein the waveguide core includes a second order non-linear optical chromophore.

17. A method of modulating light, comprising:
passing light through an active optical waveguide including an electro-optic composite including a polymer having the structure 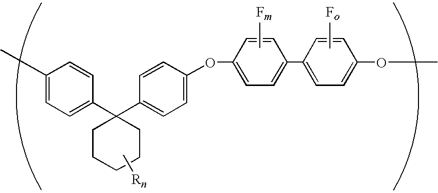
and a nonlinear optical chromophore having the structure D-π-A, wherein:
R is an alkyl, aryl, heteroalkyl, or heteroaryl, group,
D is a donor,
π is a π electron conjugated bridge,
A is an acceptor,
n=0-4,
m=1-4, and
o=1-4; and
applying a modulation voltage through the optical waveguide.

18. The method of modulating light of claim 17, further comprising:
passing light to the active optical waveguide through a passive optical waveguide including a polymer having the structure

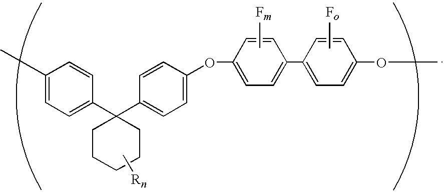

19. The method of modulating light of claim 18, wherein the passive optical waveguide and the active optical waveguide adjoin one another through a taper or a butt joint.
